(19) United States
(12) Patent Application Publication
(10) Pub. No.: US 2015/0096246 A1
(43) Pub. Date: Apr. 9, 2015

(54) ESCAPE BASE ON A ROOF

(71) Applicant: Ya-Ching CHAN, Yun Lin Hsien (TW)

(72) Inventor: Ya-Ching CHAN, Yun Lin Hsien (TW)

(21) Appl. No.: 14/270,331

(22) Filed: May 5, 2014

(30) Foreign Application Priority Data
Oct. 7, 2013 (TW) 102218696

(51) Int. Cl. E04D 13/03; E06B 3/30; E04D 13/04; E06B 5/11

(52) U.S. Cl. CPC E04D 13/0335; E06B 5/11; E06B 3/308; E04D 13/04; E06B 2009/002
USPC 52/203

(57) ABSTRACT

An escape base on a roof includes a base having an exit, a first shielding portion on a first side of the exit, and a second shielding portion on a second side of the exit opposite to the first side of the exit. The first shielding portion includes a first stop wall extending upward from an outer edge of the first shielding portion. A first shield wall extends outward from the first stop wall. A space is defined between the first shield wall and the first stop wall. The second shielding portion can include a second stop wall extending upward from an outer edge of the second shielding portion, and a second shield wall extends outward from the second stop wall, defining a space between the second shield wall and the second stop wall. The base provides sufficient spaces for receiving waterproof glue for fixing the base to the roof.

### BACKGROUND OF THE INVENTION

This application claims the benefit of Taiwan Utility Model Application Ser. No. 102218696 filed Oct. 7, 2013, the entirety of which is herein incorporated by reference.

The present invention relates to an escape base on a roof and, more particularly, to an escape base securely bonded to a roof of a house to prevent water leakage into an interior of the house.

A roof of an iron-sheet house is generally provided with a skylight for escape purposes. With reference to FIG. 3, this structure generally includes a roof 1′ and a base 2′. An opening 11′ is preserved in the roof 1′ and has an area smaller than that of the base 2′. The base 2′ includes an exit 21′ and a cover 22′ for covering the exit 21′. After the base 2′ covers the opening 11′ and is fixed to the roof 1′ by fasteners, waterproof glue 3′ is applied along a periphery of the base 2′ to prevent rainwater from entering the iron-sheet house.

However, there is no sufficient space between the periphery of the base 2′ and an upper side of the roof 1′ for receiving the waterproof glue 3′ for fixing purposes. The glue at the connection area between the base 2′ and the roof 1′ is liable to crack and fall off such that rainwater will flow into an interior of the iron-sheet house through the crack and the gap resulting from falling of the glue, resulting in leakage of water.

### BRIEF SUMMARY OF THE INVENTION

An objective of the present invention is to provide an escape base securely bonded to a roof of a house to prevent water leakage into an interior of the house.

An escape base on a roof according to the present invention includes a base having an exit, a first shielding portion on a first side of the exit, and a second shielding portion on a second side of the exit opposite to the first side of the exit. The first shielding portion includes a first stop wall extending upward from an outer edge of the first shielding portion. A first shield wall extends outward from the first stop wall. A space is defined between the first shield wall and the first stop wall.

In an embodiment, the second shielding portion includes a second stop wall extending upward from an outer edge of the second shielding portion. A second shield wall extends outward from the second stop wall. A space is defined between the second shield wall and the second stop wall.

Waterproof glue is filled into the spaces to prevent rainwater from entering a house including the roof. Since the base according to the present invention provides sufficient spaces for the waterproof glue, the glued section will not crack due to stamping by human or animal, providing an ideal design.

The present invention will become clearer in light of the following detailed description of illustrative embodiments of this invention described in connection with the drawings.

### DESCRIPTION OF THE DRAWINGS

FIG. 1 is a perspective view of an escape base on a roof according to the present invention.

FIG. 2 is a cross sectional view of the escape base of FIG. 1 mounted on a roof

FIG. 3 is a cross sectional view of a conventional escape base mounted on a roof.

### DETAILED DESCRIPTION OF THE INVENTION

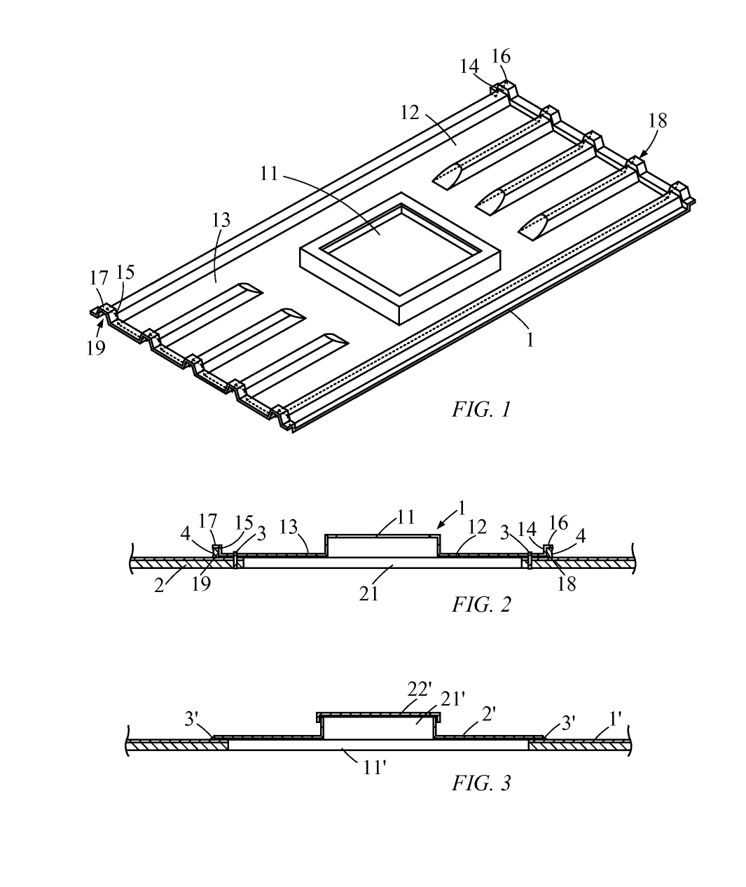

With reference to FIGS. 1 and 2, an escape base on a roof according to the present invention includes a base 1 having an exit 11, a first shielding portion 12 on a first side of the exit 11, and a second shielding portion 13 on a second side of the exit 11 opposite to the first side of the exit 11. The first and second shielding portions 12 and 13 can be of a shape corresponding to a roof 2 on which the escape base is mounted such that the first and second shielding portions 12 and 13 can completely overlap with the roof 2. As an example, the first and second shielding portions 12 and 13 can be wavy or glazed steel tiles.

The first shielding portion 12 includes a first stop wall 14 extending upward from an outer edge of the first shielding portion 12. A first shield wall 16 extends outward from the first stop wall 14. A space 18 is defined between the first shield wall 16 and the first stop wall 14. The second shielding portion 13 includes a second stop wall 15 extending upward from an outer edge of the second shielding portion 13. A second shield wall 17 extends outward from the second stop wall 15. A space 19 is defined between the second shield wall 17 and the second stop wall 15.

As indicated in FIG. 2, the base 1 is placed on the roof 2 to cover an opening 21 of the roof 2 and is fixed by fasteners 3 to the roof 2. Due to provision of the first and second stop walls 14 and 15 respectively extending upward from the outer edges of the first and second shielding portions 12 and 13 and due to provision of the first and second shield walls 16 and 17 respectively extending outward from the first and second stop walls 14 and 15, a space 18 is defined between the first shield wall 16, the first stop wall 14, and the roof 2, and another space 19 is defined between the second shield wall 17, the second stop wall 15, and the roof 2. Waterproof glue 4 is filled into the spaces 18 and 19 to prevent rainwater from entering a house including the roof 2. Since the base 1 according to the present invention provides sufficient spaces 18 and 19 for the waterproof glue 4, the glued section will not crack due to stamping by human or animal.

Although specific embodiments have been illustrated and described, numerous modifications and variations are still possible without departing from the scope of the invention. The scope of the invention is limited by the accompanying claims.

1. An escape base on a roof comprising: a base including an exit, a first shielding portion on a first side of the exit, and a second shielding portion on a second side of the exit opposite to the first side of the exit, with the first shielding portion including a first stop wall extending upward from an outer edge of the first shielding portion, with a first shield wall extending outward from the first stop wall, and with a space defined between the first shield wall and the first stop wall.

2. The escape base on a roof as claimed in claim 1, with the second shielding portion including a second stop wall extending upward from an outer edge of the second shielding portion, with a second shield wall extending outward from the second stop wall, and with a space defined between the second shield wall and the second stop wall.
